(19) United States
(12) Patent Application Publication
(10) Pub. No.: US 2026/0079031 A1
(43) Pub. Date: Mar. 19, 2026

(54) MULTI-AXIAL MULTI-MODAL OPTICAL TACTILE SENSOR

(71) Applicant: SmartHap LLC, Charlottesville, VA (US)

(72) Inventor: Bingxu Li, Charlottesville, VA (US)

(73) Assignee: SmartHap LLC, Charlottesville, VA (US)

(21) Appl. No.: 18/885,470

(22) Filed: Sep. 13, 2024

(51) Int. Cl. G01D 5/353

(52) U.S. Cl. CPC G01D 5/35341

(57) ABSTRACT

A sensing device comprising an optical tactile sensor that comprises a sensing block is provided. The sensing block is made of a light-transmitting and elastic base material, and comprises a plurality of sensing cells. The sensing device may further comprise an optic fiber, a light sensor, and a calibration cell. A method of making the sensing device is also provided. The optical tactile sensor can provide multi-axial and multi-modal capabilities to practical applications.

### BACKGROUND OF THE INVENTION

The advancement of haptic science and haptic-related technology is greatly hindered by sensors that provide limited information with limited fidelity. Such limitations fundamentally block haptic science from testing entire classes of hypotheses. Similarly, touch-based devices are left without effective tactile feedback because they are constrained to force and force-derived information like contact pressure. To address this tactile information bottleneck, there exists a need for sensors that can quantitatively measure skin deformation in near real-time with high spatial and temporal resolution. There also exists a need for sensors that can collect information that is well-correlated with human psychophysical perception.

Tactile information is typically elicited via direct physical contact between our skin and objects. Research indicates that the human sense of touch primarily relies on skin deformation during contact with objects, which activates mechanoreceptors embedded within the skin. These mechanoreceptors transmit signals to the central nervous system (CNS), enabling the brain to make perceptual judgments about the softness, texture, or other characteristics of the object. Recent studies have further revealed that 3D spatiotemporal cues generated from skin deformation—such as contact area, curvature, eccentricity, and penetration depth—are strongly correlated with human psychophysical responses during interactions with elastic stimuli. There exists a need for sensors that can directly measure these cues.

A variety of tactile sensing mechanisms have been developed, ranging from rigid body mechanical structures to compliant soft devices, and to recently discovered mid-air sensing methods that use air-flow and ultrasound waves. These mechanisms have shared limitations in size, power consumption, and bio-compatibility. Optical sensing mechanisms are less constrained by these limitations, and hold significant promise for rapid and dependable signal responses due to their notable speed and sensitivity. However, its application has thus far been limited in tactile sensing to the detection of contact force. Also, existing imaging-based sensors often lack direct measurements of mechanical cues, require additional components like cameras and advanced image processing algorithms, and are typically constrained to predefined visual markers, which limits their adaptability and integrability in practical applications. There exists a need for sensors that contribute an optical sensing mechanism that offers the dimensions and resolution to alleviate the tactile information bottleneck, while also being light, soft, and fast.

The improved sensor of the present invention draws inspiration from the structure and function of the mechanoreceptors embedded in human skin, mirroring the sensory processes that underlie human touch perception. This sensor aims to replicate the human touch system's complexity, capturing the full range of contact mechanics and extracting meaningful tactile information akin to human skin. The sensor's components are engineered such that they can mimic the location and function of the four types of mechanoreceptors found in human fingertips—where their density is highest—each responsible for detecting different types of mechanical stimuli:

Merkel Cells (SA-I) and Meissner's Corpuscles (RA-I): Located closer to the skin surface (epidermis level), these receptors have small, sharp receptive fields and are crucial for detecting sustained pressure and transient responses to stimulation onset and offset.

Ruffini Endings (SA-II) and Pacinian Corpuscles (RA-II): Situated deeper in the skin (dermis level), these receptors have larger, less defined receptive fields and are responsible for detecting skin stretch, tension, rapid vibrations, and deep pressure.

By integrating these afferent-inspired functionalities, the sensor of the present invention can emulate the softness and elasticity of human skin while capturing a wide range of tactile information. This biomimetic approach ensures a comprehensive understanding of contact dynamics and advances the engineering of tactile sensors toward more accurate, human-like touch perception.

### SUMMARY

In one aspect, the present invention provides a sensing device. The sensing device comprises an optical tactile sensor that comprises a sensing block. The sensing block comprises a top surface, a bottom surface, and a side surface.

The sensing block is made of a light-transmitting and elastic base material. The sensing block comprises a plurality of sensing cells disposed within the sensing block. The light transmittance of the base material is different from the light transmittance of any of the sensing cells.

In one embodiment, the sensing device further comprises an optic fiber, a light sensor, and a calibration cell.

In one embodiment, the Young's modulus of the base material is about 10 kPa-1 MPa, optionally about 40 kPa-50 kPa.

In one embodiment, the base material is a silicone elastomer.

In one embodiment, the silicone elastomer of the base material is Ecoflex™, optionally Ecoflex™00-30.

In one embodiment, the Young's modulus of a sensing cell is about 10 kPa-1 MPa, optionally about 40 kPa-50 kPa.

In one embodiment, the sensing cell comprises a silicone elastomer.

In one embodiment, the silicone elastomer of the sensing cell is Ecoflex™, optionally Ecoflex™00-30, optionally Ecoflex™GEL.

In one embodiment, the sensing cell comprises a conductive material, optionally a metal, optionally copper, optionally a copper power with an optional size of mesh 325.

In one embodiment, the ratio of copper to silicone elastomer in the sensing cell is about 10%-40% by weight, optionally about 10%-30% by weight, optionally about 10% or about 30% by weight.

In one embodiment, the light transmittance of the base material is about 50% to 90%, optionally 75-85%.

In one embodiment, the light transmittance of the sensing cell is about 50% to 90%, optionally 75-85%.

In one embodiment, the sensing block comprises a pair of sensing cells. The pair of sensing cells comprises a top sensing cell and a bottom sensing cell. The top of the top sensing cell aligns with the top surface of the sensing block, and the bottom of the bottom sensing cell aligns with the bottom surface of the sensing block. Optionally, the top of the top sensing cell is parallel to the bottom of the bottom sensing cell.

In one embodiment, the top sensing cell and the bottom sensing cells within each pair have the same size and shape. The top sensing cell and the bottom sensing cell are invertedly placed within the sensing block.

In one embodiment, the shape of the top and bottom sensing cells is a dome.

In one embodiment, the diameter of the dome base is about 1-4 mm, optionally about 2 mm.

In one embodiment, the height of the dome base is about 1-4 mm, optionally about 2 mm.

In one embodiment, the shape of the top and bottom sensing cells is a pyramid.

In one embodiment, the sensing device includes an array of pairs of sensing cells in square, rectangular, or circular arrangement.

In one embodiment, the sensing device further comprises an elongated sensing cell embedded in the sensing block. The angle formed by the long axis of the elongated sensing cell and the top surface of the sensing block is about 10-80°, optionally about 30-60°. The light transmittance of the elongated sensing cell is different from that of the pair of sensing cells.

In one embodiment, the elongated sensing cell comprises copper powder with an optional size of 325 mesh and a silicone elastomer, optionally Ecoflex™ GEL. Optionally, the ratio of copper to silicone elastomer is about 10%-30% by weight.

In one embodiment, the sensing device further comprises a pair of electrodes to form a triboelectric nanogenerator with the pair of sensing cells.

In one aspect, the present invention provides a sensing system. The sensing system comprises an optical tactile sensor and a processing unit. The optical tactile sensor comprises a sensing block, an optic fiber, a light sensor, and a calibration cell. The processing unit configured to detect at least one of multi-axial (including, e.g., normal, tangential, and circumferential) pressure, temperature, humidity, impact, vibration, and triboelectric effect based on a signal captured by the light sensor.

In one aspect, the present invention provides a method of making a sensing device. The sensing device comprises an optical tactile sensor that comprises a sensing block. The sensing block has a top surface, a bottom surface, and a side surface. The sensing block is made of a light-transmitting and elastic base material. The sensing block comprises a plurality of sensing cells disposed within the sensing block. The light transmittance of the base material is different from that of any of the sensing cells. The method comprises the steps of: making the sensing block using the base material, leaving hollow spaces for the sensing cells; and injecting a mixture of elastomer and conductive material into the hollow spaces to form sensing cells.

In one embodiment, the method comprises the steps of:
making the sensing block using the base material, leaving hollow spaces for the sensing cells;
injecting a mixture of elastomer and conductive material into the hollow spaces to form the sensing cells
providing a housing for the light sensor;
placing the light sensor in the housing;
connecting one end of an optic fiber to the light sensor in the housing and the other end of the optic fiber to a sensing cell.

In one embodiment, the method comprises the step of making a mold for the sensing block.

In one embodiment, the method comprises the step of making a mold and/or housing using 3-D printing.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the disclosure. The figures are provided to facilitate understanding of the disclosure without limiting the breadth, scope, scale, or applicability of the disclosure. The drawings are not necessarily made to scale. Details that may be apparent or unnecessary may be omitted to save space or for more effective illustration. Some embodiments may be practiced with additional components or steps and/or without all of the components or steps that are illustrated.

FIG. 1 illustrates an example of a sensing block with a pair of sensing cells.

FIG. 2 illustrates an example of a sensing device with an optical tactile sensor, optic fibers, light sensors, and a calibration cell.

FIG. 3 illustrates an example of a sensing block with an array of sensing cells.

FIG. 4A illustrates an example of a sensing block with an array of sensing cells.

FIG. 4B illustrates the top view of FIG. 4A, with the sensing cells numbered.

FIG. 4C illustrates an example of a sensing block with an array of elongated sensing cells.

FIG. 5 illustrates a sensing block with a pair of electrodes.

FIG. 6 illustrates the process of signal sensing and processing of a sensing system.

FIG. 7 illustrates a set of normal force validation result of a sensing device.

FIG. 8 illustrates tangential force detection by a sensing device.

FIG. 9 illustrates circumferential force detection by a sensing device.

FIG. 10 illustrates the sensitivity of different sensing cells to normal and circumferential forces.

FIG. 11 illustrates the temperature sensitivity of a sensing device.

FIG. 12 illustrates the temperature/humidity sensing capability of a sensing device with and without a contact event.

FIG. 13 illustrates the response to targeted force application of a sensing device.

FIG. 14 illustrates the impact detection of a sensing device.

FIG. 15 illustrates the vibration detection of a sensing device.

FIG. 16 illustrates the triboelectric effect detection of a sensing device.

### DETAILED DESCRIPTION

The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

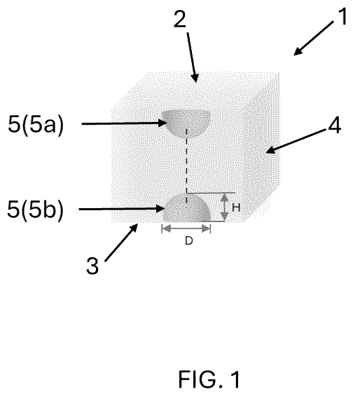

FIG. 1 shows an embodiment of the present invention: a sensing device comprising an optical tactile sensor that comprises a sensing block (1). The sensing block has a top surface (2), a bottom surface (3), and a side surface (4).

The sensing block (1) is made of a light-transmitting and elastic base material. the sensing block (1) comprises a plurality of sensing cells (5), disposed within the sensing block (1).

The base material can allow a significant amount of light pass through. In one embodiment, the light transmittance of the base material is about 50% to 90%, optionally about 75-85%.

The base material can undergo elastic deformation under load, meaning it can exhibit certain behavior (e.g. linear) up to a certain limit, and it can return to its original shape after the stress is removed. In one embodiment, the Young's modulus of the base material is about 10 kPa-1 MPa, optionally about 45 kPa-50 kPa to resemble human skin at fingertips. The modulus of the base material can be increased or reduced depending on the material the sensor interacts with. For example, it can be as soft as the skin on the eyelids (<40 kPa) or as stiff as the soles of the feet (>700 kPa).

In one embodiment, the base material is a silicone elastomer. A variety of curable silicone elastomers can be used. An example is the EcoFlex™ rubbers sold by Smooth-On, Inc (Macungie, PA).

The sensing cell (5) has a light transmittance different from the light transmittance of the base material. The light transmittance of the sensing cell is about 50% to 90%, optionally about 75-85%.

The sensing cell (5) can also be made of an elastic material such as a silicone elastomer. A variety of curable silicone elastomers can be used. An example is the EcoFlex™ rubbers sold by Smooth-On, Inc (Macungie, PA). An example of Ecoflex™ is Ecoflex™ 00-30. Other examples include, e.g., SYLGARD™ 182 and SYLGARD™ 184 sold by the Dow Chemical Company.

The sensing cell (5) can comprise a conductive material. A variety of conductive materials can be used. In one embodiment, copper power is used. In one embodiment, the size of the copper powder is 325 mesh.

In one embodiment, the ratio of conductive material (for example copper powder) to the elastic material (for example silicone elastomer) in the sensing cell is about 10%-40% by weight. Optionally, the ratio is about 10% 30% by weight.

In one embodiment, the sensing cells (5) exist in pairs. In FIG. 1, the top sensing cell (5a) aligns with top surface (2) and the bottom sensing cell (5b) aligns with bottom surface (3). Optionally, the top of the top sensing cell (5a) is parallel to the bottom of the bottom sensing cell (5b).

In one embodiment, the top sensing cell (5a) has the same size and shape as the bottom sensing cell (5b). The pair of sensing cells are invertedly placed within the sensing block (1).

The sensing cells can take a variety of different shapes, for example domes and pyramids. In one embodiment, the shape of the sensing cell is a dome, as illustrated in FIG. 1. In one embodiment, the diameter of the dome base (D) is about 1-4 mm, optionally 2 mm. In one embodiment, the height of the dome (H) is about 1-4 mm, optionally 2 mm.

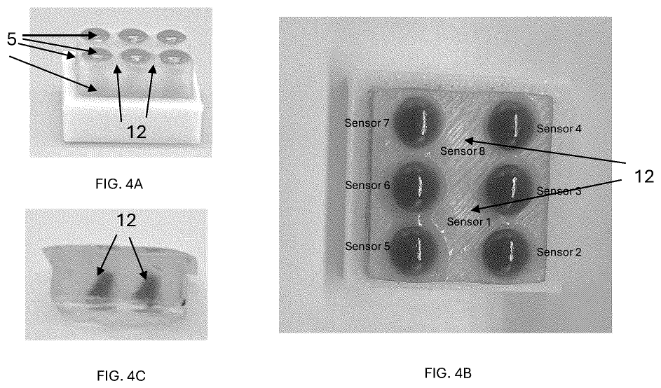

Pairs of sensing cells (5) can form an array within the sensing block (1). The array can take a variety of layouts, for example rectangular, square, or circular. For geometric layout, with uniform spatial coverage, a 2×2 square array or a 2×3 rectangular array can be used. Optionally, for radial distribution, a circular array with one sensing pair in the center and 6 equidistant sensing pairs around it can be used. In FIGS. 4A and 4B, a 2×3 rectangular array of sensing pairs is used.

The sensing cell (5) located at the top and bottom surfaces of the sensing block is more sensitive to forces normal to the surface of the sensing block.

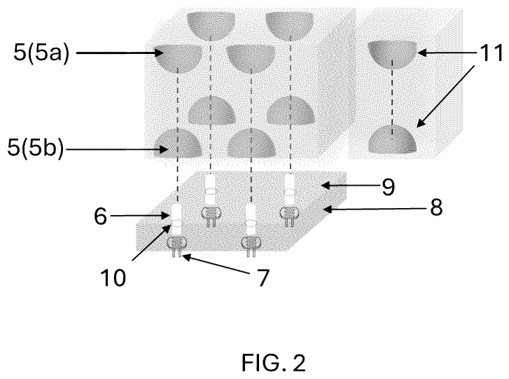

In FIG. 2, the optic fibers (6) connect the sensing cells (5) to light sensors (7). The light sensors (7) can be enclosed in a housing (8). Optionally, the housing (8) has a lid (9). The lid (9) can have holes (10) through which the optic fibers (6) come out of the housing.

Optionally, double-wall, single-mode optic fibers are used. Double-wall structure offers enhanced mechanical strength, resistance and durability to environmental influence; and single-mode fibers offer smaller core diameter (8 to 10 μm) and enhanced sensitivity to light intensity changes by minimizing dispersion and attenuation.

The light sensor (7) can detect light intensity changes. Two examples of light sensors are light-dependent resistors (LDRs) and photodiodes. LDR is an efficient option due to its small size, low cost, and the ability to detect ambient light. Photodiodes have larger size and higher costs, but can provide high temporal resolution data.

LDRs can detect light intensity ranging from very low light levels up to bright high light levels. In terms of light transmittance, LDRs can respond to a wide range (from 0.01% to nearly 100%). However, since their response is logarithmic, meaning they are more sensitive to changes in lower light levels than in very bright conditions, making them suitable for detecting general ambient light levels but less effective for precise measurements. Also, the frequency response of LDRs is quite low, typically ranging from a few Hz up to around 10-50 Hz.

Photodiodes can detect light transmittance from very low levels (sub-0.01%) up to nearly 100%. They have high sensitivity to light intensity changes, making them suitable for precision applications but with higher costs. They also have high frequency response up to GHz range.

In FIG. 2, calibration cell (11) can be an additional component that detects ambient light, temperature, and humidity of the surrounding environment, excluded from any contact event. Optionally, the calibration cells (11) are in pairs. Optionally, the calibration cell pair consists of a top cell and a bottom cell. Optionally, the calibration cells (11) are similar to the sensing cells (5) in terms of materials, shape, or size. Optionally, the calibration cells (11) are disposed within the sensing block (1). Optionally, any sensing cell (6) can function as a calibration cell if it is not used for direct pressure sensing.

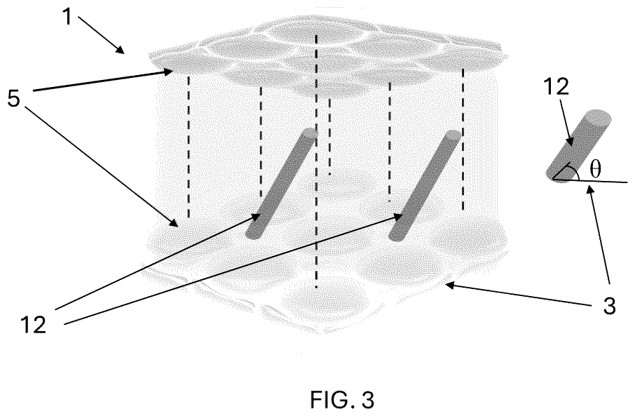

In one embodiment, the sensing cells can include an elongated sensing cell (12). In FIGS. 3 and 4A-4C, the elongated sensing cells (12) are positioned inside the sensing block (1). Optionally, the angle formed by the axis of the elongated sensing cells (12) and the bottom surface (3) θ is about 10-80°, optionally about 30-60°. The cross section of the elongated sensing cell can be a variety of shapes. Optionally, the cross section of the elongated sensing cell is a circle. Optionally, the diameter of the circle is about 1-3 mm. Optionally, the distance between either end of the elongated sensing cell and the surface of the sensing block is not less than 2 mm.

The elongated sensing cells (12) have a light transmittance different from the light transmittance of the pair of sensing cells (5a) and (5b). The light transmittance of the elongated sensing cells is optionally about 50% to 90%, for example about 75-85%.

The elongated sensing cell (12) can also be made of an elastic material such as a silicone elastomer. A variety of curable silicone elastomers can be used. An example is the EcoFlex™ rubbers sold by Smooth-On, Inc (Macungie, PA). An example of Ecoflex™ is Ecoflex™ GEL. Silicone oil (for example, sold by Sigma-Aldrich®) can also be used to modulate the light transmittance and the elastic modulus by dilution with silicone elastomer at ratio of 100%, 200%, and 300% by weight.

The elongated sensing cell (12) can comprise a conductive material. A variety of conductive materials can be used. In one embodiment, copper powder is used. In one embodiment, the size of the copper powder is 325 mesh.

In one embodiment, the ratio of conductive material (for example copper powder) to the elastic material (for example silicone elastomer) in the elongated sensing cell is about 10%-30% by weight.

The elongated sensing cell (12) located inside the sensing block (1) is more sensitive to forces tangential or circumferential to the surfaces (for example, top surface (2) or side surface (4) of the sensing block (1)).

The quantity and distribution of elongated sensing cells within the sensing block can be chosen based on needs. In FIGS. 4(A)-(C), two elongated sensing cells (12) are used.

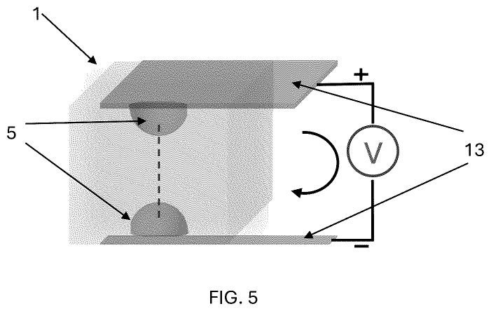

In one embodiment, as illustrated in FIG. 5, a pair of electrodes (13) are included in the device to form a triboelectric nanogenerator (TENG) with a pair of sensing cells (5). When the sensing cells (5) are pressed against each other and are then separated, they exchange electrons due to differences in their electron affinity, creating a triboelectric charge on their surfaces. This electric potential difference drives electrons to flow between the two electrodes (13) connected to the materials, converting mechanical energy into electrical energy. This triboelectric effect can detect changes of contact state in a very short amount of time, which can be used in trigger point and edge detection. This mechanism enables the detection of rapid contact events and the generation of instantaneous power, mirroring the functionality of Meissner's corpuscles, which are sensitive to transient pressure.

In one embodiment, the optical tactile sensor, optic fiber, light sensor, and calibration cell as described above can be combined with a processing unit to form a sensing system. The processing unit is configured to detect at least one of multi-axial pressure, temperature, humidity, impact, vibration, and triboelectric effect based on a signal captured by the sensing block.

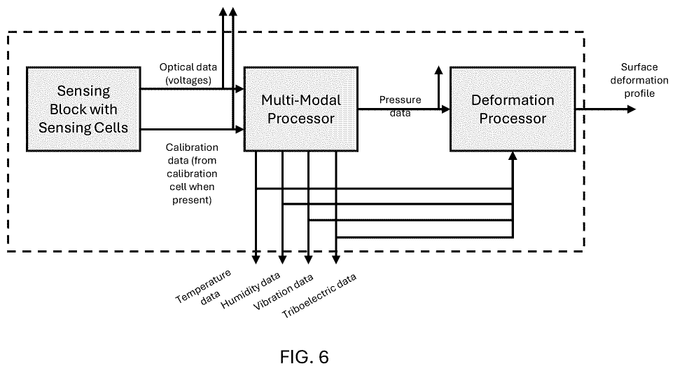

For example, the light intensity changes captured by the light sensor can be proportional to the magnitude of pressure. Multi-axial (such as normal, tangential, and circumferential) pressures can be detected by sensing cells placed in various locations within the sensing block. Impact and vibration can be detected with the combination of pressure and time. Changes in temperature and relative humidity can also be detected because they correlate to structural deformation of the sensing cells. The processing unit can include a processor that is optionally multimodal, as illustrated in FIG. 6. The optical data from the sensing block with the sensing cells, and optionally with the calibration data, can be processed to output data pertaining to multi-axial pressure, temperature, humidity, impact, vibration, and triboelectric effect.

The processing unit can further include a processor to provide a 3-D surface deformation profile.

The sensing device of the present invention can be made with a variety of methods. In one embodiment, the method of making the sensing device includes the steps of a) making the sensing block using the base material, leaving hollow spaces for the sensing cells and b) injecting a mixture of silicone elastomer and conductive material into the hollow spaces to form sensing cells. Optionally, the base material can cure at room temperature. Optionally, the silicone elastomer used to form the sensing cells can cure at room temperature.

Optionally, the sensing block is made by adding elastic base material to a mold. Optionally, the mold is made with 3D-printing method.

In one embodiment, the method of making the sensing device further includes the steps of connecting a sensing cell with a light sensor via an optic fiber. Optionally, the light sensor (7) is enclosed in a housing (8), as illustrated in FIG. 2. Optionally, the housing (8) is made with 3D-printing. Optionally, a lid (9) is provided. Optionally, the lid (9) is made with 3D-printing. The lid (9) can have a hole (10) that aligns with the sensing cell at the bottom of sensing block. The size of the hole (10) can be slightly bigger than the cross section of the optic fiber (6) to let the optic fiber (6) pass through. One end of the optic fiber (6) can be connected to a light sensor (7) enclosed in the housing, while the other end of the optic fiber (6) can pass through the hole (10) on the lid (9), leaving a segment of about 0.5-1 mm outside the hole (10).

Optionally, the top sensing cell (5a) of a sensing pair is made before the bottom sensing cell (5b). Optionally, one end of the optic fiber (6) is inserted into the bottom sensing cell (5b) before it is fully cured. Optionally, the optic fiber (6) can be secured by injecting silicone elastomer filling the space between the hole (10) and the optic fiber (6). Optionally, the silicone elastomer can cure at room temperature.

### EXAMPLE

A 10×10 mm square sensing block with a height of 12 mm was made using Ecoflex™00-30 as the base material. The base material was injected into a 3D-printed mold and let cure for approximately 60 minutes. The sensing block was designed to have a 2×3 array of sensing pairs located near the surfaces and two elongated sensing cells embedded in the sensing block. Each of the sensing pairs includes a top sensing cell and a bottom sensing cell that are both dome-shaped with the dome top facing inward the sensing block and the dome bottom aligned with the surface of the sensing block. Pictures of the sensing block are shown in FIGS. 4A and 4B, with each sensing pair and each elongated sensing cell given a sensor number.

The height and the diameter of the dome are both about 2 mm. Each of the elongated sensing cells is in the shape of a tilted pillar about 3 mm in length and about 1 mm in diameter. The angle between the long axis of the tilted pillar and the bottom surface of the sensing block is about 30°.

The sensing pairs were made by injecting a mixture of 325 mesh copper powder and Ecoflex™ GEL at a weight ratio of about 10% into the corresponding hollow spaced in the sensing block and let cure for approximately 60 minuets. The elongated sensing cells were made by injecting a mixture of 325 mesh copper powder and Ecoflex™ GEL (diluted by silicone oil at 100% by weight) at a weight ratio of about 30% into the corresponding hollow spaced in the sensing block and let cure for approximately 2 hours.

The sensing block was placed between a linear actuator and a digital force gauge. The optical sensor was connected to light sensors for sensor readings. The force gauge reading would provide the ground-truth data for validation.

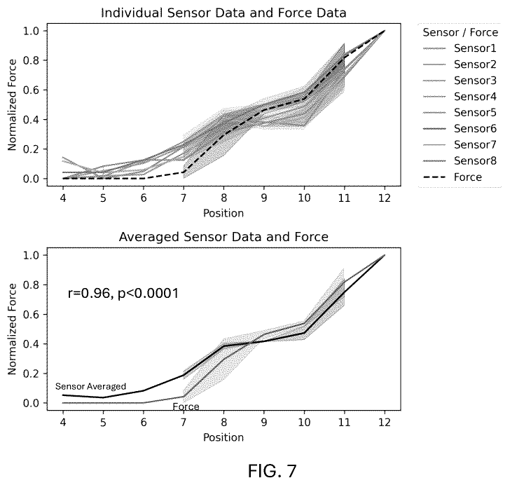

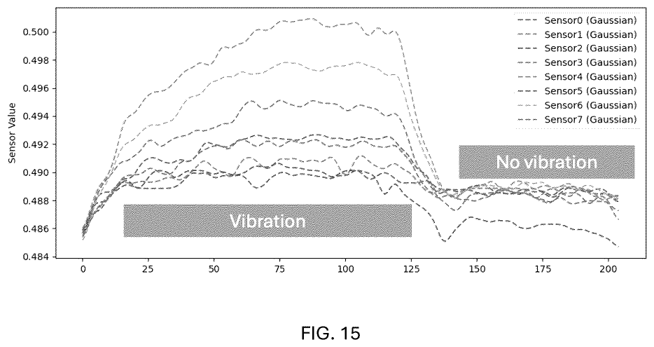

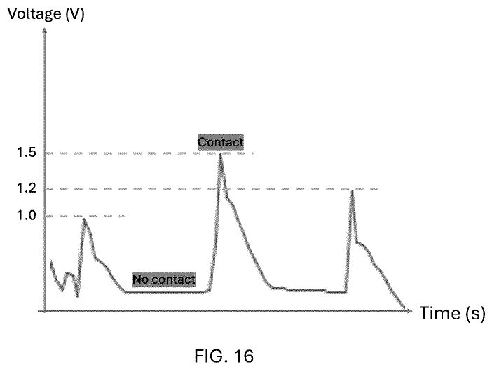

The results of the tests on the sensing blocks are presented in FIGS. 7-16. In FIG. 7, the reading from each sensor as well as the force gauge reading was plotted in the top graph. The bottom plot shows the averaged value from the 8 sensors compared against the ground-truth data. Pearson correlation method was used to evaluate the statistical significance between the pressure readings from the sensing block and the ground-truth data. The results indicate a high correlation of r=0.96 and p value<0.0001.

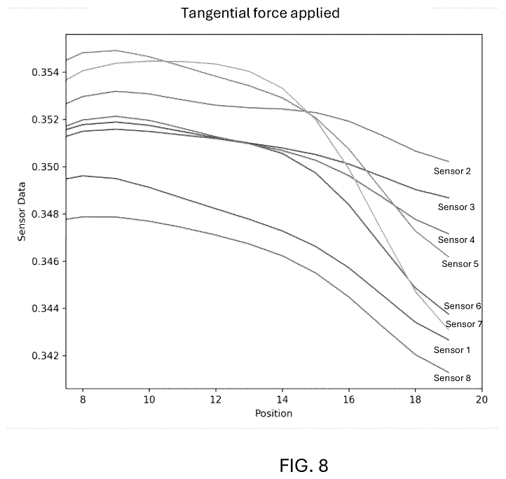

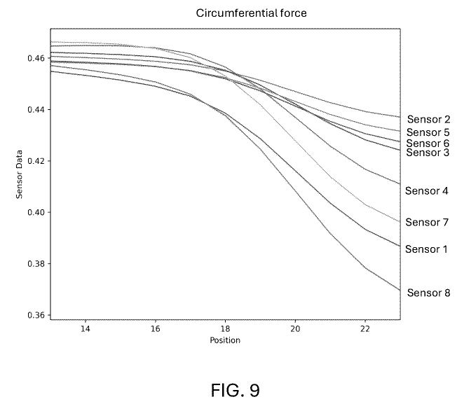

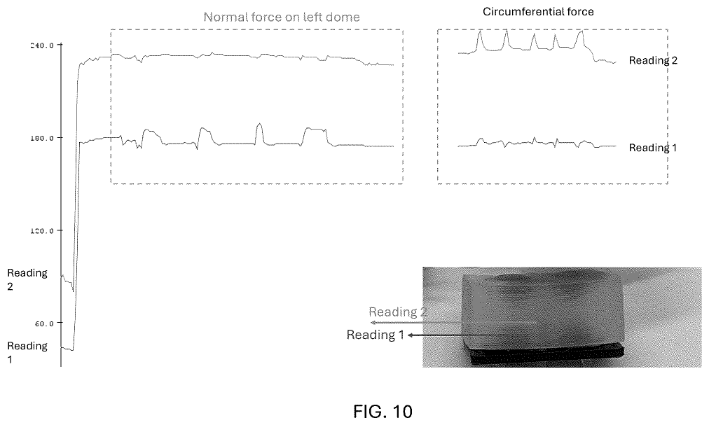

FIG. 8 and FIG. 9 show the results of tangential and circumferential force detection, respectively. In both cases, the elongated sensing cells, Sensors 1 and 8 were more sensitive to the forces applied. FIG. 10 compares data from a dome-shaped sensing pair on the left and an elongated sensing cell in the middle when normal and circumferential forces were applied on the sensing block. The results indicate that the sensing pair is more sensitive to normal force and the elongated sensing cell is more sensitive to circumferential force.

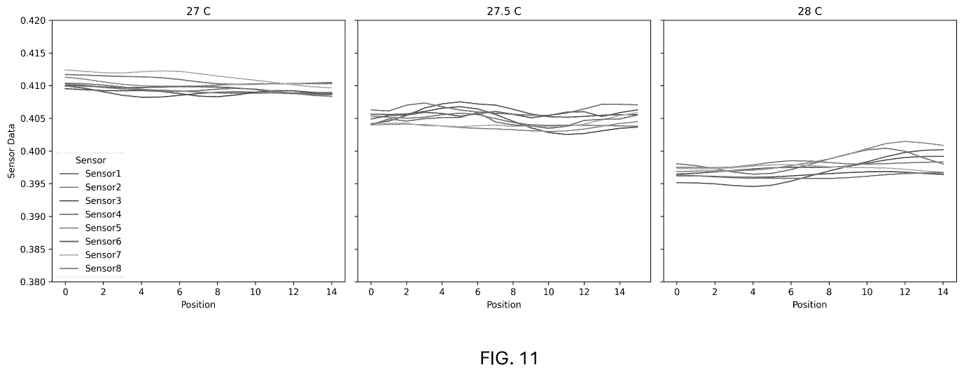

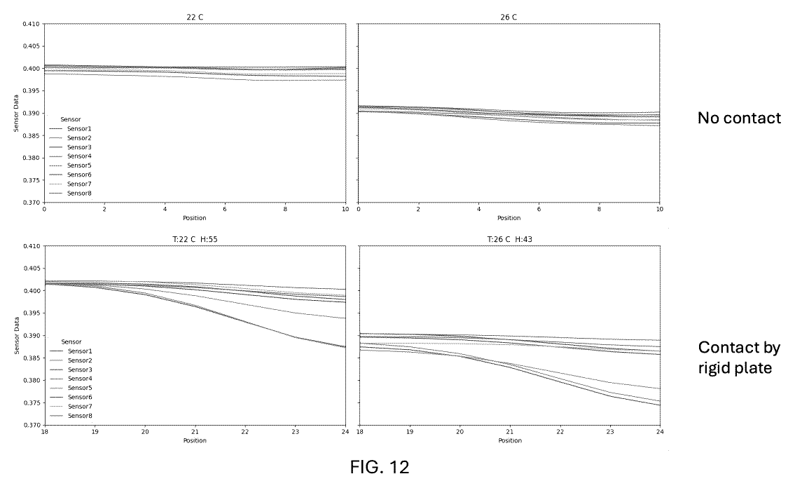

FIG. 11 shows the temperature sensitivity of the sensors. FIG. 12 compares the temperature effect with and without contact.

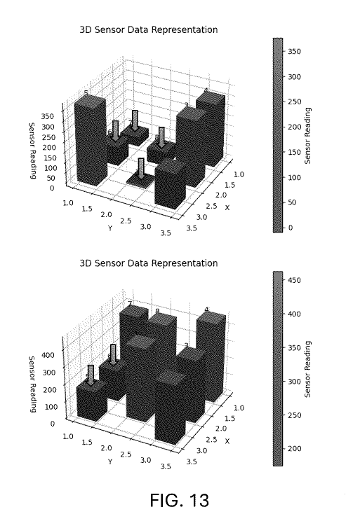

FIG. 13 shows the results of targeted force application directed to individual sensors, indicating that the cross talk between different sensors was not significant.

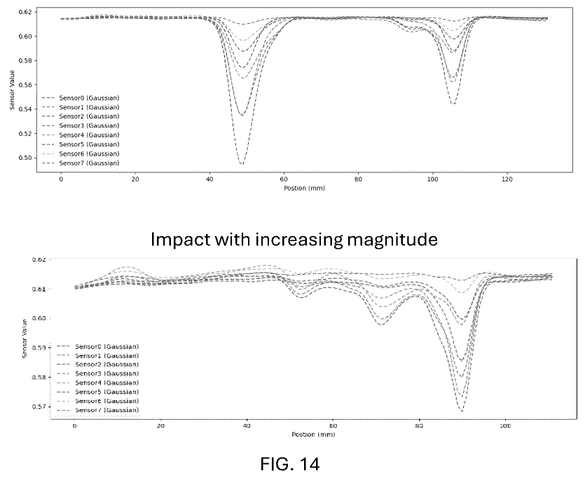

FIGS. 14-16 show the sensing block's capability of detecting impact, vibration, and triboelectric effect, respectively.

The application of the present invention can be multi-axial and multi-modal, allowing it to capture a comprehensive range of information of contact mechanics. The term “multi-axial” refers to the sensing device's ability to detect pressure along multiple axes, including, e.g., in normal, tangential, and circumferential directions. The term “multi-modal” refers to the sensing device's ability to capture different types of data through a processing unit based on a signal collected from the sensing block, including temperature, humidity, impact, vibration, and triboelectric effect. By combining multi-axial and multi-modal sensing capabilities, comprehensive levels of detail and fidelity in tactile information for contact-based events can be obtained.

1. A sensing device comprising:
an optical tactile sensor that comprises:
a sensing block, wherein
the sensing block comprises a top surface, a bottom surface, and a side surface,
the sensing block is made of a light-transmitting and elastic base material,
the sensing block comprises a plurality of sensing cells disposed within the sensing block, and
the light transmittance of the base material is different from the light transmittance of any of the sensing cells.

2. The sensing device of claim 1, further comprising:
an optic fiber;
a light sensor; and
a calibration cell.

3. The sensing device of claim 1, wherein the Young's modulus of the base material and the Young's modulus of any of the sensing cells are about 10kPa-1 MPa.

4. The sensing device of claim 3, wherein the base material is a silicone elastomer with a Young's modulus of about 40 kPa-50 kPa.

5. The sensing device of claim 1, wherein the light transmittance of the base material is about 75-85%.

6. The sensing device of claim 1, wherein the plurality of sensing cells comprises a pair of sensing cells comprising a top sensing cell and a bottom sensing cell, and wherein the top of the top sensing cell aligns with the top surface of the sensing block, and the bottom of the bottom sensing cell aligns with the bottom surface of the sensing block.

7. The sensing device of claim 6, wherein the top of the top sensing cell is parallel to the bottom of the bottom sensing cell.

8. The sensing device of claim 6, wherein within the pair of sensing cells, the top sensing cell and the bottom sensing cell have the same size and shape, and wherein the top sensing cells and the bottom sensing cell are invertedly placed within the sensing block.

9. The sensing device of claim 8, wherein the shape of the top and bottom sensing cells is a dome.

10. The sensing device of claim 6, wherein the plurality of sensing cells further comprises an elongated sensing cell embedded in the sensing block, wherein the angle formed by the long axis of the elongated sensing cell and the bottom surface of the sensing block is about 10°-80°, and wherein the light transmittance of the elongated sensing cell is different from the light transmittance of the pair of sensing cells.

11. The sensing device of claim 10, wherein the angle formed by the long axis of the elongated sensing cell and the bottom surface of the sensing block is about 30°-60°.

12. The sensing device of claim 10, wherein the elongated sensing cell comprises copper powder and a silicone elastomer, and wherein the ratio of the copper powder to the silicone elastomer is about 10%-30% by weight.

13. The sensing device of claim 6, further comprising a pair of electrodes to form a triboelectric nanogenerator with the pair of sensing cells.

14. The sensing device of claim 1, wherein the sensing cells comprise a silicone elastomer and a conductive material.

15. The sensing device of claim 14, wherein the conductive material is copper powder, and wherein the ratio of the copper powder to the silicone elastomer is about 10%-40% by weight.

16. A sensing system comprising:
an optical tactile sensor and a processing unit, wherein the optical tactile sensor comprises a sensing block, an optic fiber, a light sensor, and a calibration cell, wherein:
the sensing block comprises a top surface, a bottom surface, and a side surface,
the sensing block is made of a light-transmitting and elastic base material,
the sensing block comprises a plurality of sensing cells disposed within the sensing block, and
the light transmittance of the base material is different from the light transmittance of any of the sensing cells,
and wherein the processing unit is configured to detect at least one of multi-axial pressure, temperature, humidity, impact, vibration, and triboelectric effect based on a signal captured by the sensing block.

17. The sensing system of claim 16, wherein the plurality of sensing cells comprises a pair of sensing cells that comprises a top sensing cell and a bottom sensing cell, and wherein:
the top of the top sensing cell aligns with the top surface of the sensing block, and
the bottom of the bottom sensing cell aligns with the bottom surface of the sensing block.

18. The sensing system of claim 17, wherein the plurality of sensing cells further comprises an elongated sensing cell embedded in the sensing block, wherein the angle formed by the long axis of the elongated sensing cell and the bottom surface of the sensing block is about 10°-80°, and wherein the light transmittance of the elongated sensing cell is different from the light transmittance of the pair of sensing cells.

19. A method of making the sensing device of claim 1, comprising:
making the sensing block using the base material, leaving hollow spaces for the sensing cells; and
injecting a mixture of elastomer and conductive material into the hollow spaces to form the sensing cells.

20. The method of claim 19, further comprising:
providing a housing for a light sensor;
placing the light sensor in the housing; and
connecting one end of an optic fiber to the light sensor in the housing and the other end of the optic fiber to a sensing cell.
